(19) United States
(12) Patent Application Publication
(10) Pub. No.: US 2012/0044030 A1
(43) Pub. Date: Feb. 23, 2012

(54) RELAY WITH MULTIPLE COILS

(76) Inventor: Sung Jen WU, Shulin City (TW)

(21) Appl. No.: 12/857,561

(22) Filed: Aug. 17, 2010

(51) Int. Cl. H01H 51/06

(52) U.S. Cl. 335/136

(57) ABSTRACT

A relay with multiple coils includes a base having at least one fixed contact disposed thereon. At least one coil assembly is mounted on the base. Each coil assembly has a plurality of attracted ends formed thereon. A spring member is pivotally connected to the base. The spring member has at least one moving contact disposed thereon and movably connected with the at least one fixed contact for providing a switching effect. The spring member has a magnetic member rivetedly mounted thereon and corresponding to the attracted ends of the at least one coil assembly. The spring member provides a restoring force on the at least one moving contact and the magnetic member, such that the relay acts as a switch for opening/closing a circuit connected to the relay.

### BACKGROUND OF THE INVENTION

1. Field of the Invention

The present invention relates to a relay with multiple coils, and more particularly to a relay having multiple coils disposed thereon for increasing an efficiency of an electromagnetic induction and lowering a consumption of the coils.

2. Description of Related Art

A relay is an electrically operated switch for controlling a circuit by applying a low electric current. The most common types of relays used are electromechanical relays, reed relays, and solid state relays, etc. A conventional electromagnetic relay in accordance with the prior art comprises an iron core. A single coil is wound around the iron core. A magnet is disposed above the iron core and the single coil. A spring is connected to the magnet for restoring the magnet. Accordingly, two distal ends of the single coil is respectively applied two different voltages to generate an electric current for passing through the single coil, such that a magnetic field is induced by the electric current for attracting the magnet to move toward the iron core. And when no electric current passes through the single coil, the magnetic field is disappeared. The magnet is drawn back by the spring.

However, the conventional electromagnetic relay only has the single coil. The induced magnetic field can be enhanced without changing the input voltages by increasing a length or a diameter of the coil or increasing a length of the iron core. This causes an increase of a size of the single coil and is inconvenient to dispose on a small-scale relay.

The present invention has arisen to mitigate and/or obviate the disadvantages of the conventional electromagnetic relay with a single coil.

### SUMMARY OF THE INVENTION

The main objective of the present invention is to provide an improved relay with multiple coils for increasing an induced magnetic field.

To achieve the objective, the relay with multiple coils in accordance with the present invention includes a base having at least one fixed contact disposed thereon.

At least one coil assembly is mounted on the base. Each coil assembly comprises at least one U-shaped iron core disposed on the base. Each U-shaped iron core has two legs. Two tubular bobbins respectively and coaxially receive the two legs of each iron core. Each tubular bobbin has a square cross section. Two coils are respectively and coaxially wound around the two tubular bobbins. Each tubular bobbin which is wound by the corresponding coil has an attracted end formed thereon and located at one end of the corresponding leg of the iron core.

A spring member is pivotally connected to the base. The spring member has at least one moving contact disposed on one end thereof and movably connected with the at least one fixed contact of the base for providing a switching effect. The spring member has a magnetic member rivetedly mounted thereon and located adjacent to the at least one moving contact. The magnetic member corresponds to the attracted ends of the at least one coil assembly and is in a face-to-face relation with the attracted ends. The spring member selectively provides a restoring force on the at least one moving contact and the magnetic member.

When the at least one coil assembly is induced a magnetic field by supplying electric current, the magnetic member is magnetically attracted to move toward and connect with the attracted ends of the at least one coil assembly by the magnetic field. The spring member is driven to pivotally move toward the at least one coil assembly. The at least one moving contact moves away from the at least one fixed contact by a movement of the spring member.

When no electric current is supplied to the at least one coil assembly, the magnetic member is released from the attracted ends. The spring member provides the restoring force to move the magnetic member and the at least one moving contact backward. The at least one moving contact moves to connect with the at least one fixed contact. Accordingly, the relay acts as a switch for adapting to open/close a circuit connected to the relay.

In accordance with another aspect of the present invention, each tubular bobbin has a round cross section.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a preferred embodiment of a relay with multiple coils in accordance with the present invention;

FIG. 2 is an assembled perspective view of the preferred embodiment of the relay with multiple coils in accordance with the present invention;

FIGS. 3-4 are operational side plane views of the preferred embodiment of the relay with multiple coils in accordance with the present invention;

FIG. 5 is an assembled perspective view of a second embodiment of the relay with multiple coils in accordance with the present invention;

FIGS. 6-7 are operational side plane views of the second embodiment of the relay with multiple coils in accordance with the present invention; and

FIG. 8 is an exploded perspective view of a third embodiment of the relay with multiple coils in accordance with the present invention.

### DETAILED DESCRIPTION OF THE INVENTION

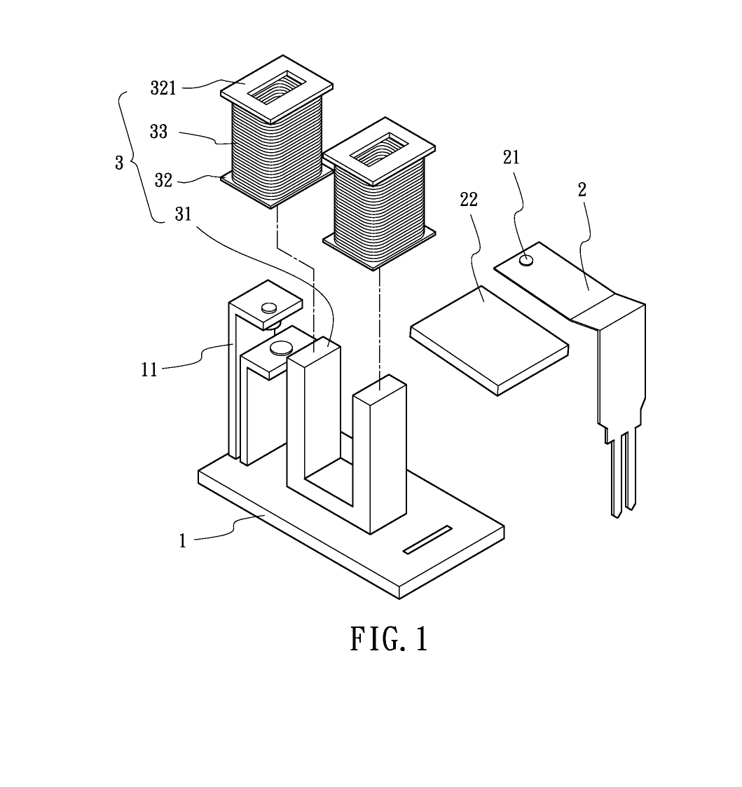

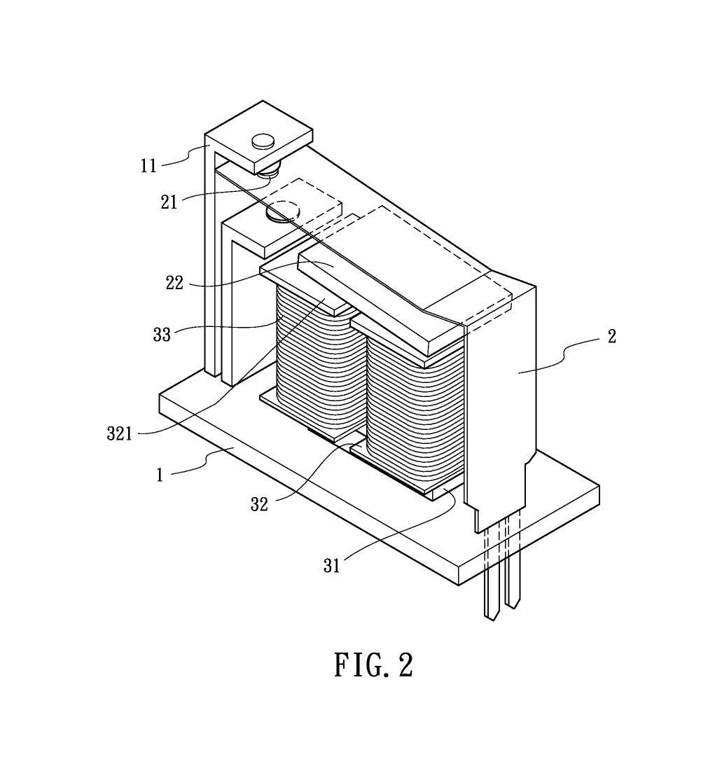

Referring to the drawings and initially to FIGS. 1-2, a relay with multiple coils in accordance with a preferred embodiment of the present invention is in a flapping motion version and comprises a base 1 having a wall (not numbered) vertically and laterally disposed on a top thereof. The base 1 has a fixed contact 11 disposed on the wall thereof.

A coil assembly 3 is mounted on the top of the base 1 and located adjacent to the wall. The coil assembly 3 comprises a U-shaped iron core 31 having two spaced legs (not numbered) extending upwardly therefrom. Two tubular bobbins 32 respectively and coaxially receive the two legs of the iron core 31. Each tubular bobbin 32 has a square cross section. Two coils 33 are respectively and coaxially wound around the two tubular bobbins 32. Each tubular bobbin 32 which is wound by the corresponding coil 33 has an attracted end 321 formed thereon and located at a free end of the corresponding leg of the iron core 31.

A spring member 2 is pivotally connected to the base 1. The spring member 2 has an inverted L shape with a vertical arm and a horizontal arm (not numbered). A free end of the vertical arm of the spring member 2 is fixed to the top of the base 1 and located adjacent to the coil assembly 3. The horizontal arm of the spring member 2 movably extends toward the wall of the base 1 and is slightly warped up. A free end of the horizontal arm has a moving contact 21 disposed thereon and movably correspondingly connected with the fixed contact 11 of the base 1 for providing a switching effect. The spring member 2 has a magnetic member 22 rivetedly mounted on a bottom of the horizontal arm and located adjacent to the moving contact 21. The magnetic member 22 spacedly corresponds to the attracted ends 321 of the coil assembly 3 and is in a face-to-face relation with the attracted ends 321. The spring member 2 selectively provides a restoring force on the moving contact 21 and the magnetic member 22 of the horizontal arm.

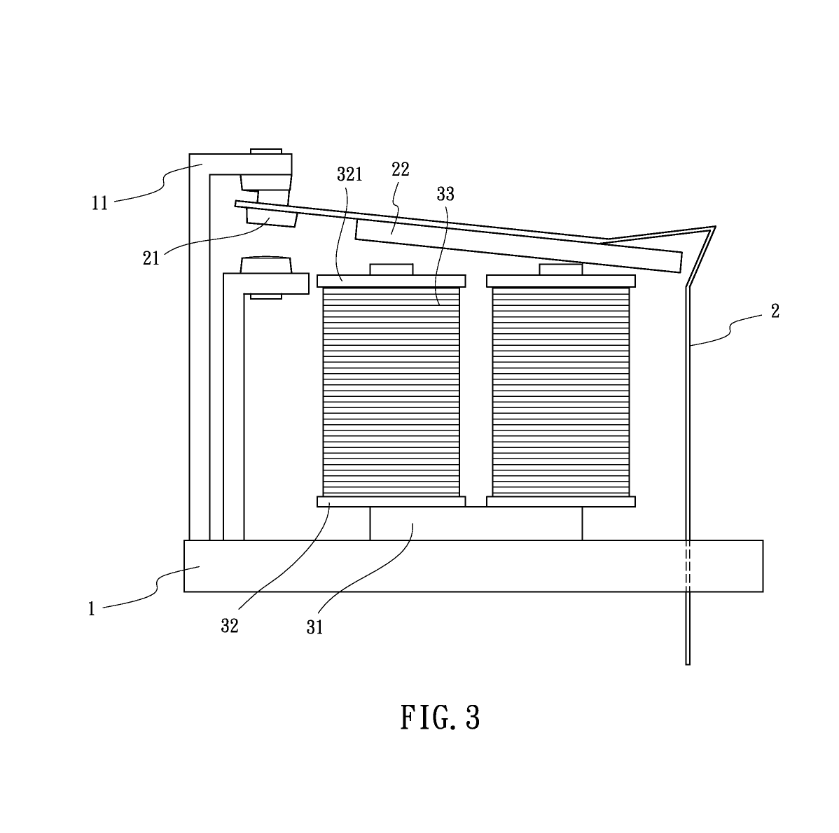

The operation of the relay with multiple coils in accordance with the present invention will be described in detailed below. As shown in FIG. 3, when each coil 33 of the coil assembly 3 is induced a magnetic field by supplying electric current, the magnetic member 22 of the spring member 2 is magnetically attracted to move toward and connect with the attracted ends 321 of the two tubular bobbins 32 by the magnetic field. The horizontal arm of the spring member 2 pivotally moves downwardly to the coil assembly 3 with the attracted magnetic member 22. The moving contact 21 moves away from the fixed contact 11 by a movement of the horizontal arm of the spring member 2.

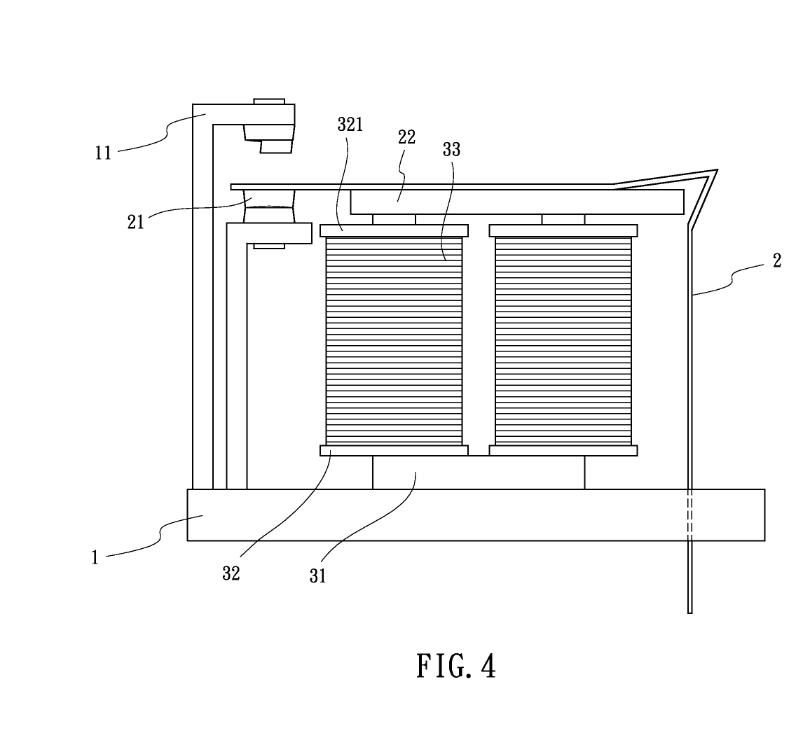

As shown in FIG. 4, when no electric current is supplied to the two coils 33 and the magnetic field is disappeared, the magnet 22 is released from the attracted ends 321. The spring member 2 provides the restoring force to draw the magnet 22 and the moving contact 21 of the horizontal arm backward. The moving contact 21 moves upwardly to connect with the fixed contact 11 again. Accordingly, the relay with multiple coils acts as a switch for opening/closing a circuit (not shown) connected to the relay.

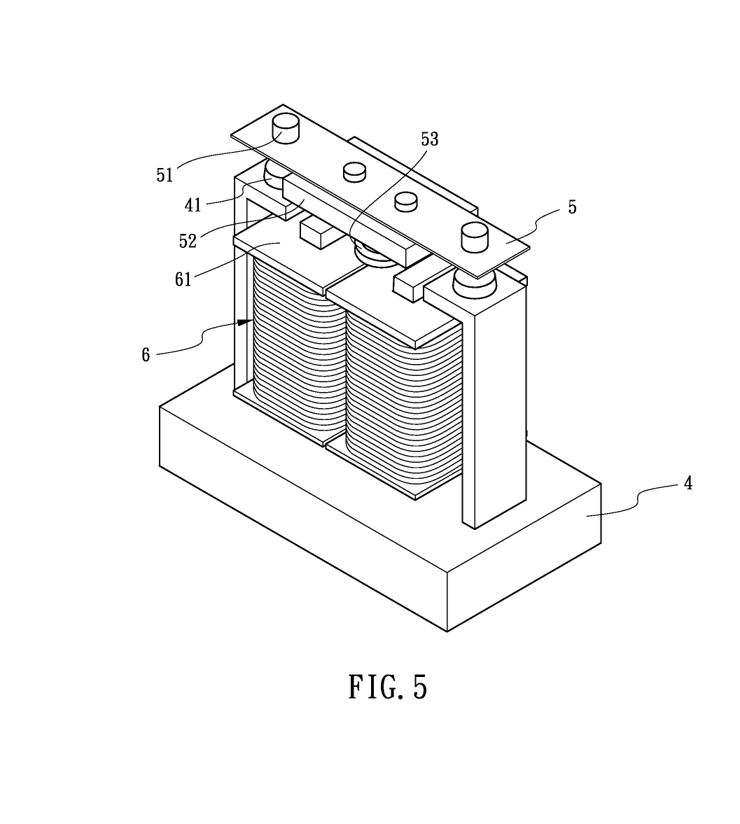

With reference to FIGS. 5-7, that shows a second embodiment of the relay with multiple coils in accordance with the present invention. The second embodiment is in a vertical motion version. The elements and effects of the second embodiment which are the same with the preferred embodiment are not described, only the differences are described. In this embodiment, the base 4 has two walls (not numbered) vertically disposed on two opposite sides of a top thereof. The base 4 has two fixed contacts 41 respectively disposed on the two walls thereof. The coil assembly 6 is mounted on the top of the base 4 and located between the two walls. The coil assembly 6 has a plurality of attracted ends 61 formed thereon

A spring member 5 is movably located above the coil assembly 6. The spring member 5 has two moving contacts 51 respectively disposed on two opposite ends thereof for corresponding to the two fixed contacts 41 of the base 4. A magnetic member 52 is rivetedly mounted on a bottom of the spring member 5 and located between the two moving contacts 51. The magnetic member 52 spacedly corresponds to the attracted ends 61 of the coil assembly 6 and is in a face-to-face relation with the attracted ends 61. A coil spring 53 is compressibly disposed between the magnetic member 52 and the attracted ends 61 of the coil assembly 6. The coil spring 53 has two ends abutting against the magnetic member 52 and the coil assembly 6.

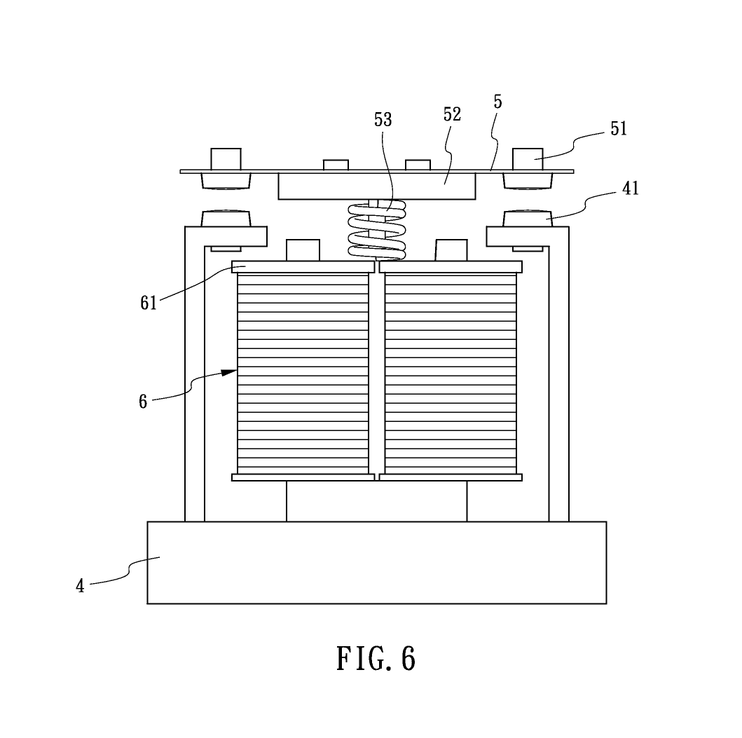

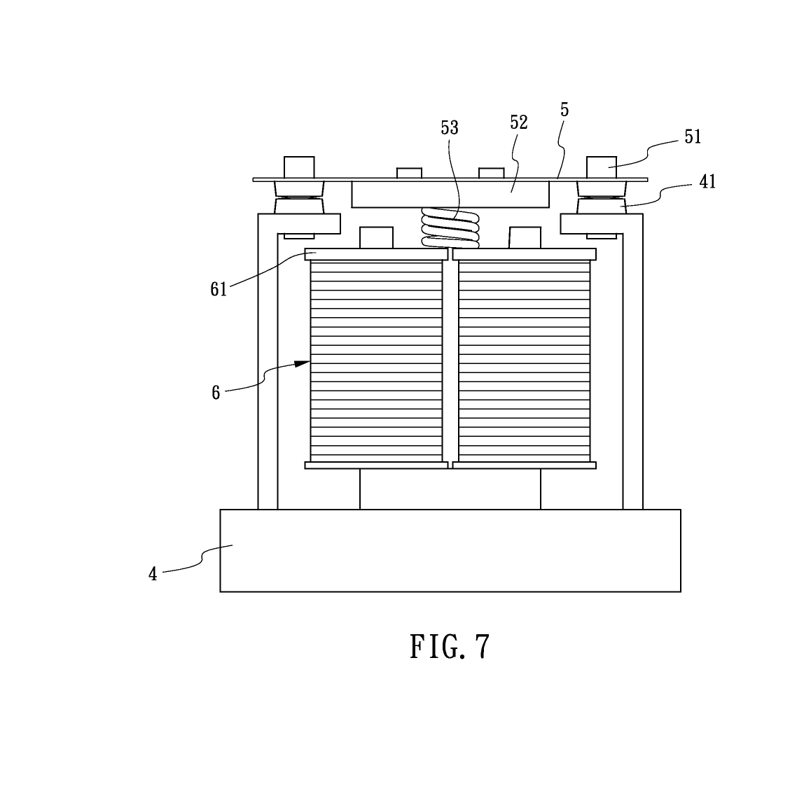

As shown in FIGS. 6-7, when the magnetic member 52 is magnetically attracted by the induced magnetic field in the coil assembly 6 and the coil spring 53 is vertically compressed by the magnetic member 52, the spring member 5 moves downwardly to the coil assembly 6 with the attracted magnetic member 52. The two moving contacts 51 simultaneously move downwardly to connect with the two fixed contacts 41 of the base 4. When no magnetic field is induced, the magnetic member 52 is released from the attracted ends 61. The coil spring 53 provides a restoring force to draw the magnetic member 52 and the two moving contacts 51 of the spring member 5 backward. The two moving contacts 51 move away from the two fixed contacts 41.

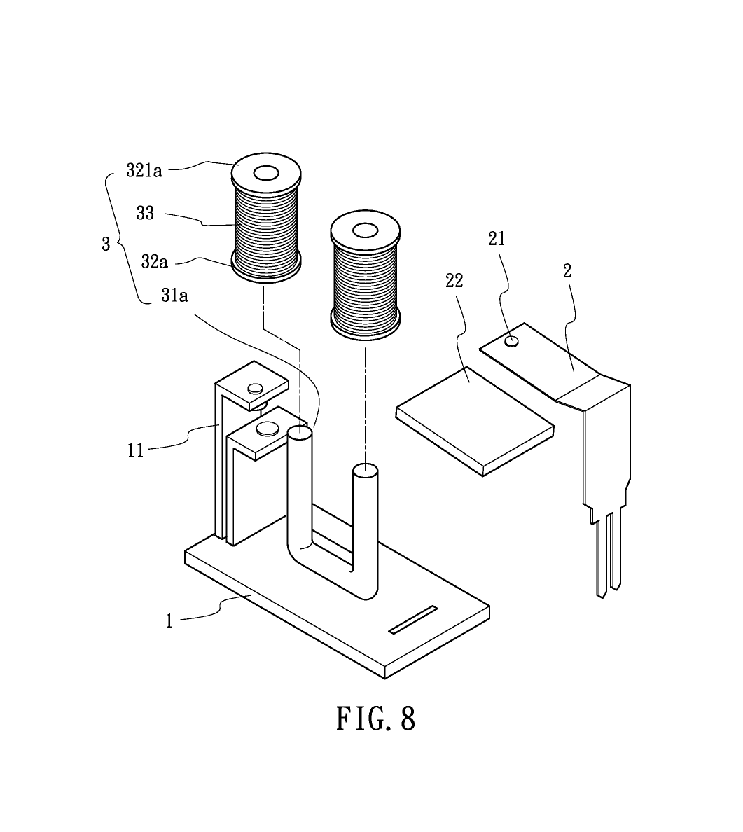

With reference to FIG. 8, that shows a third embodiment of the relay with multiple coils in accordance with the present invention. The elements and effects of the third embodiment which are the same with the preferred embodiment are not described, only the differences are described. In this embodiment, each tubular bobbin 32a has a round cross section and coaxially receives the corresponding leg of the iron core 31a.

Therefore, the induced magnetic field of the conventional relay with a single coil may be enhanced without changing the input voltages by increasing a length or a diameter of the coil or increasing a length of the iron core. The relay with multiple coils in accordance with the present invention overcomes above disadvantages by providing the multiple coils for increasing the induced magnetic field and enhancing the operation of the relay.

Although the invention has been explained in relation to its preferred embodiment, it is to be understood that many other possible modifications and variations can be made without departing from the spirit and scope of the invention as hereinafter claimed.

What is claimed is:

1. A relay with multiple coils comprising:
a base having at least one fixed contact disposed thereon;
at least one coil assembly mounted on the base, each coil assembly having a plurality of attracted ends formed thereon; and
a spring member pivotally connected to the base, the spring member having at least one moving contact disposed thereon and movably connected with the at least one fixed contact of the base for providing a switching effect, the spring member having a magnetic member rivetedly mounted thereon and corresponding to the attracted ends of the at least one coil assembly, the magnetic member being in a face-to-face relation with the attracted ends, the spring member selectively providing a restoring force on the at least one moving contact and the magnetic member;
wherein when the at least one coil assembly is induced an magnetic field by supplying electric current, the magnetic member with the spring member is magnetically attracted to pivotally move toward and connect with the attracted ends of the at least one coil assembly by the magnetic field, the at least one moving contact moving away the at least one fixed contact by a movement of the spring member; when no electric current is supplied to the at least one coil assembly, the magnetic member is released from the attracted ends, the spring member providing the restoring force to move the magnetic member and the at least one moving contact backward, the at least one moving contact moving to connect with the at least one fixed contact, such that the relay acts as a switch for adapting to open/close a circuit connected to the relay.

2. The relay with multiple coils as claimed in claim 1, wherein each coil assembly comprises at least one U-shaped iron core disposed on the base, two tubular bobbins respectively and coaxially receiving two legs of each iron core, two coils respectively and coaxially wound around the two tubular bobbins, such that each tubular bobbin wound by the corresponding coil has the attracted end for corresponding to the magnetic member.

3. The relay with multiple coils as claimed in claim 2, wherein each tubular bobbin has a round cross section.

4. The relay with multiple coils as claimed in claim 2, wherein each tubular bobbin has a square cross section.
